(19) United States
(12) Patent Application Publication
(10) Pub. No.: US 2004/0179698 A1
(43) Pub. Date: Sep. 16, 2004

(54) Digital audio player

(76) Inventor: Timothy Conner, Greenwich, CT (US)

Correspondence Address: Philip Braginsky, Scully Scott Murphy & Presser, Suite 300, 400 Garden City Plaza, Garden City, NY, 11530, US

(21) Appl. No.: 10/475,164

(22) PCT Filed: Apr. 17, 2002
(86) PCT No.: PCT/US02/12022

Related U.S. Application Data
(60) Provisional application No. 60/284,169, filed on Apr. 17, 2001.

(51) Int. Cl. H03G 3/00; H04B 1/00; G10L 11/00

(52) U.S. Cl. 381/61; 381/124; 704/272

(57) ABSTRACT

A digital audio player for soothing anxiety in an animal with housing (2), a power source mounted within the housing (2), a microcontroller (8) mounted within the housing in electrical communication with the power source, an audio coder/decoder (codec) (10) mounted with the housing in electrical and logical communication with the microcontroller (8), a solid state storage device preprogrammed with audio data designed to sooth an animals anxiety mounted with the housing (2) in electrical and logical communication to the microcontroller (8) and the codec (10), a speaker (6) in electrical communication with the codec, and a hook and loop strap to mount the housing (2) on an animal's collar. Also provided is a method using such a device for soothing anxiety in an animal.

### FIELD OF THE INVENTION

This invention generally relates to a device and method for providing audible sound to an animal. Specifically, this invention relates to a device and method for providing music for a domestic pet or animal.

### BACKGROUND OF THE INVENTION

Tens of millions of American families and hundreds of millions of families worldwide enjoy owning pets. In the United States alone, 31 million homes enjoy the friendship and companionship of pet dogs. 27 million homes own playful, furry felines. Many of the homes are multiple pet households. Latest statistics estimate that there are 53 million dogs and 59 million cats in the U.S. Definitely, cats and dogs have become part of the family.

Each year these families spend nearly $15 billion on pet food and pet care products. In addition, there are approximately 45,000 private practice veterinarians in America. Figures show that each American family spends $186.80 on dog pets and $147.19 on cat pets annually. Combined, the U.S. vet market and the pet food and supply markets are nearly $28 billion a year.

Cats and dogs, a huge segment of the pet market, have special needs. They are different animals, but many of their traits are similar. For example, both cats and dogs suffer emotionally and physically. Both cats and dogs suffer stress when families are away, or separation anxiety when they have to stay at the vet or kennel for an extended period of time. Or some may be high strung all the time. Experts say reducing stress in a pet is always helpful and can make the pet healthier.

Animal medical experts have conducted research and have come to the conclusion that soft, soothing music helps a pet cope with stress and separation anxiety.

### SUMMARY OF THE INVENTION

The invention is a musical reproducer that helps lower an animal's anxiety, without interfering with the rest of the animal's environment, household, or a kennel. In its preferred embodiment, the invention is a small, plastic, molded module that weighs little and contains a non-volatile solid state memory that is pre-programmed with soothing music. The device may provide an on and off switch and volume regulation. It also has an internal speaker, and a power source. The product is adapted to easily attach to a pet collar.

By attaching the invention to the collar and close to the pet's ears, the volume can be adjusted to a comfortable level for the pet to listen and yet not disturb the rest of the household, kennel or environment. The invention can easily travel with the pet in the family vehicle and to the veterinarian or kennel. It can also be attached to the pet's bed or to an airline carrier.

### DESCRIPTION OF THE DRAWINGS

FIG. 1 is a depiction of the invention with housing and components.

FIG. 2 is bottom view of the invention.

FIG. 3 is a side view of an embodiment of the invention showing the hook and loop strap.

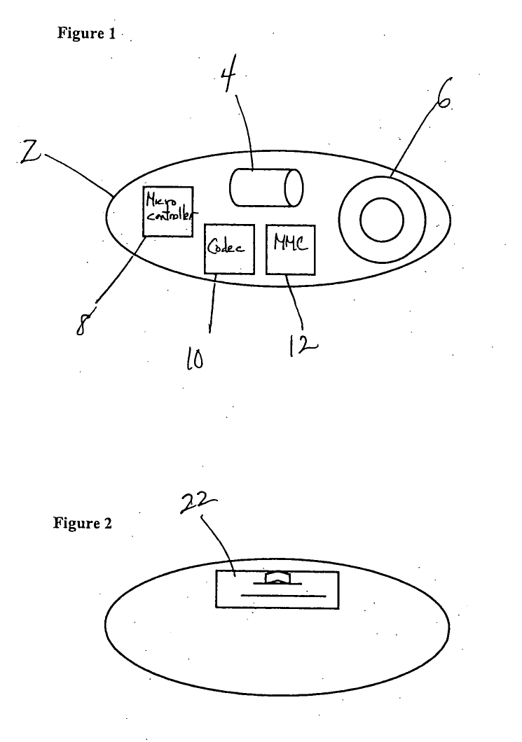

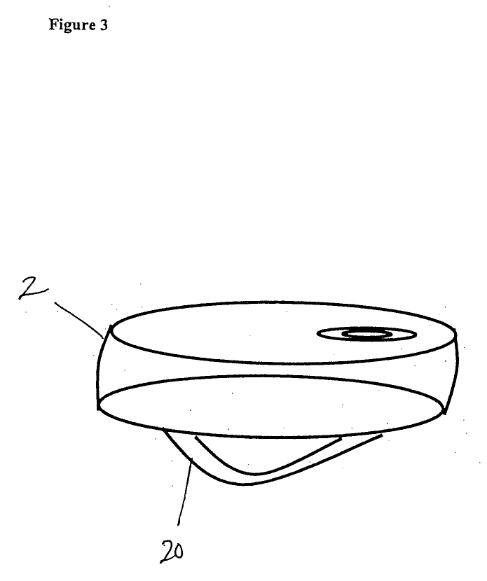

### DETAILED DESCRIPTION OF THE INVENTION

In the preferred embodiment, the invention is a small plastic module that weighs less than several ounces and contains non-volatile solid state memory that is pre-programmed with sounds soothing to an animal. The device has a hook and loop strap mechanism that is adapted to be removably attached to a dog or cat collar. It has a power switch, a small speaker, and replaceable power source such as a battery. Alternatively, it may have a volume regulation, indication lights and other accessories.

The invention is adapted to be attached to the pet collar and remain close to the pet's ears. The preferred embodiment provides music at a comfortable volume level for the pet but low enough not to disturb the rest of the environment.

Dogs, cats and many other animals have greater sound sensitivity then humans. While the invention can be used for any animal, the preferred embodiment is for dogs and cats. Dogs sound sensitivity is in the range of 67 Hz to 45 KHz. Cats are slightly more sensitive with a range of 45 Hz to 64 KHz.

At the intensity of 20 Db, dogs sensitivity ranges from approximately 200 Hz to 35 KHz. In the middle range of frequencies humans hear, dogs and cats hear at much lower levels than humans.

It has been shown that anxiety caused by separation or lack of self-confidence can be very troublesome for a dog. These emotions often cause a dog to act destructively or to urinate without control. For those problems it is common for vetenarians to suggest playing music for a dog to ease its anxiety.

It has also been shown that music increases milk production in cows, as well as, calming cats, horses and other animals.

The device comprises a housing 2 that contains a power source which may be a battery. The battery powers a small speaker 6 which is positioned in the housing such that sound generated by the speaker easily emanates to an animal's ear which is in close proximity to the housing. The speaker generates sound from signals stored and reproduced by electrical components within the housing.

The components are in electrical communication with the battery for power. They are also in electrical and logical communication with the speaker 6 which converts the digital signal to acoustic waves audible to the animal.

The primary electrical components include a microcontroller 8, an MPEG audio codec 10 and a solid state storage device 12. The preferred embodiment is of a simple MP3 player. The design is intended to maximize audio quality and sturdiness while reducing power consumption and size.

A preferred embodiment utilizes a MultiMediaCard with a capacity of either 16, 32 or 64 MB. These cards are extremely light weight and small, typically measuring 32×24×1.4 mm. Since these cards are non-volatile solid-state, there are no moving parts to minimize power consumption. Also data is not lost if power is lost. The cards are robust and sturdy and able to withstand abusive conditions.

The microcontroller 8 is preferably a low power CMOS such as an 8-bit microcontroller based on RISC architecture. One example is the Atmel® 8-bit AVR microcontroller that combines 8K bytes of on chip programmable flash memory, 512 bytes of EEPROM and 512 of SRAM on a monolithic chip. This chip provides for two independent registers to be accessed in one single instruction in one clock cycle. This achieves high throughputs while minimizing power consumption.

The audio codec 12 is preferably an MPEG layer 3 audio decoder that includes a digital to analog converter. It is also preferable for the decoder to have an earphone amplifier to eliminate the need for a separate amplifier in the player. A chip that contains a high-performance, low power digital signal processor core and high quality oversampling variable sample rate digital to analog converter is preferred. A power down mode on the chip will conserve power when the device is not in use.

The device is used by placing it in a position relative to a pet's ears so that the pet may hear the audio signal emanating from the speaker. The device may be attached to the pet's collar or may be attached to a bed or carrier. The audio signal is of a volume such that the pet hears it when it is close to its ears. The volume may be adjustable and the device may be moved and removed from the pets collar.

The audio signal is preprogrammed and designed to sooth anxiety in an animal. This may comprise soft “noise” or static or music. Preferably, a hook and loop system 20 is used on a strap to attach the device to the pet's collar. The hook and loop system may be adapted to include an adhesive patch attached to the back of the module and the opposite patch attached to another object such as a bed or carrier. Additionally, a clip such as those common on a pager or a mobile telephone may be used to attach to the pet's collar, bed or carrier. Further, the collar may be constructed with the device integrally incorporated.

The device might also be placed in a cover for added protection and convenience. The cover is similar to that used for mobile telephones such that the cover is soft and attaches to the desired location. The device can be conveniently placed into, and taken out of, the cover. The cover protects the device from the environment and allows the device to be removed without unhooking the cover.

The volume regulator may be continuously variable or variable by steps such as low, medium and high. The volume regulator may also incorporate the power switch which turns the device on and off.

The power source 4 is preferably a small battery of sufficient voltage to power the speaker and chip for a desired number of hours of play. The battery could be a “half-double A” or some other size. The battery may also be rechargeable. The device may be adapted to plug into a wall outlet to recharge the battery. The device has a door 22 that provides access to the battery for changing it.

The size, weight and shape of the device are such that the device is unobtrusive to the pet. The device may also attach to a halter of a horse or some other mechanism to place it near the ears of any animal. The invention may be adapted for use with any type of animal.

The invention encompasses a device and method for providing music for a domestic pet or animal. Accordingly, it should be readily appreciated that the device and method disclosed has many practical applications. Additionally, although the preferred embodiment has been illustrated and described, it will be obvious to those skilled in the art that various modifications can be made without departing from the spirit and scope of this invention. Such modifications are to be considered as included in this disclosure unless expressly recited differently.

What is claimed:

1. A method of soothing anxiety in an animal comprising:
mounting a digital audio player with a solid state memory storing preprogrammed audio signals to an animal;
reproducing the audio signals through a speaker mounted in the audio player that are audible for the animal to hear wherein, the audio signals are designed to sooth animal anxiety.

2. A method of soothing anxiety in an animal as in claim 1 wherein:
the digital audio player comprises:
a housing;
a power source mounted within the housing;
a microcontroller mounted within the housing in electrical communication with the power source;
an audio coder/decoder (codec) mounted within the housing in electrical and logical communication with the microcontroller,
a solid state storage device mounted within the housing in electrical and logical communication to the microcontroller and the codec; and
the speaker is in electrical communication with the codec.

3. A method of soothing anxiety in an animal as in claim 1 wherein:
the audio signal is preprogrammed music.

4. A method of soothing anxiety in an animal as in claim 1 wherein:
the digital audio player is mounted by a hook and loop strap to an animals collar.

5. A digital audio player for soothing anxiety in an animal comprising:
a housing;
a power source mounted within the housing;
a microcontroller mounted within the housing in electrical communication with the power source;
an audio coder/decoder (codec) mounted within the housing in electrical and logical communication with the microcontroller,
a solid state storage device preprogrammed with audio data designed to sooth an animals anxiety mounted within the housing in electrical and logical communication to the microcontroller and the codec;
a speaker in electrical communication with the codec; and
a hook and loop strap to mount the housing on an animal's collar.

6. A digital audio player as in claim 5 further comprising:
a non-rigid cover designed to protect the housing from moisture and wear.

7. A digital audio player as in claim 5 wherein:
the storage device is a multimedia card.
